(19) United States
(12) Patent Application Publication
(10) Pub. No.: US 2025/0139800 A1
(43) Pub. Date: May 1, 2025

(54) METHOD FOR SENSOR DATA PROCESSING AND PROCESSING DEVICE

(71) Applicant: Robert Bosch GmbH, Stuttgart (DE)

(72) Inventors: Alexander Bartler, Villingen-Schwenningen (DE); Benedikt Loesch, Stuttgart (DE); Goetz Kuehnle, Ludwigsburg (DE); Kilian Rambach, Stuttgart (DE); Maurice Quach, Ditzingen (DE); Michael Ulrich, Stuttgart (DE); Michael Schoor, Stuttgart (DE); Oliver Kern, Renningen (DE); Ruediger Jordan, Stuttgart (DE); Yuri Feldman, Haifa (IL)

(21) Appl. No.: 18/888,862

(22) Filed: Sep. 18, 2024

(30) Foreign Application Priority Data
Oct. 25, 2023 (DE) 10 2023 210 550.0

(51) Int. Cl. G06T 7/514; G06T 7/11

(52) U.S. Cl. CPC G06T 7/514; G06T 7/11

(57) ABSTRACT

A method for sensor data processing of sensor data of a surroundings sensor. The method includes providing the sensor data of the surroundings sensor acquiring at least one target object in the surroundings of the sensor, calculating a point cloud including a spatial distribution of a plurality of points assigned to respective reflections of the target object from the sensor data, inputting the points and the information sections of the sensor data respectively assigned to them into a trained processing model, calculating feature vectors assigned the points by the processing model depending on the input, outputting the points and the assigned feature vectors for further processing by a further processing model. A processing device is also described.

### CROSS REFERENCE

The present application claims the benefit under 35 U.S.C. § 119 of German Patent Application No. DE 10 2023 210 550.0 filed on Oct. 25, 2023, which is expressly incorporated herein by reference in its entirety.

### FIELD

The present invention relates to a method for sensor data processing. The present invention also relates to a processing device.

### BACKGROUND INFORMATION

Driver assistance systems and autonomous driving functions in vehicles require accurate acquisition of the surroundings of the vehicle. Surroundings sensors, for example radar sensors in addition to cameras, are used for this purpose. These surroundings sensors provide sensor measurement data from which sensor data in the form of spectra are calculated by means of preparation or processing. The sensor data are used to calculate a point cloud comprising a spatial distribution of a plurality of points assigned to respective reflections of target objects in the surroundings of the vehicle. The position, pose, class and, if necessary, other object properties of the target objects are ascertained from these point clouds using surroundings sensing algorithms.

With the advent of deep learning, traditional algorithms are increasingly being replaced by object detection networks and similar methods. In this case, a deep neural network ascertains the probability of existence, size, pose and class of the target objects, i.e. oriented bounding boxes (OBB). Only once this is completed are the detected OBBs tracked over time.

Because of the smaller number of points, object detection networks are not yet widely used with radar sensors. If they are, it is typically the points of the point cloud that are used as the input for the object detection networks. The points are calculated from the sensor data and represent a compressed form of the original information of the sensor data that does not include a large amount of the original information.

### SUMMARY

According to the present invention, a method for sensor data processing of a surrounding sensor is provided. According to an example embodiment of the present invention, the method includes providing the sensor data of the surroundings sensor acquiring at least one target object in the surroundings of the sensor; calculating a point cloud including a spatial distribution of a plurality of points assigned to respective reflections of the target object from the sensor data; inputting the points and the information sections of the sensor data respectively assigned to them to a trained processing model; calculating feature vectors assigned to the points by the processing model depending on the input; and outputting the points and the assigned feature vectors for further processing by a further processing model.

The data output for further processing by the further processing model can thus have a smaller data size and still contain as much information from the sensor data as possible. The memory space needed for the data stored for further processing can be reduced. The data rate for output for further processing by the further processing model can be reduced. The input data made available for further processing can have a higher information content. It is moreover also possible to produce sensor-independent input data for further processing.

According to an example embodiment of the present invention, a data interface transmitting the output of the processing model as the input to the further processing model can have a lower bandwidth and transmit a smaller amount of data than when the sensor data as a whole are used as the input data for further processing. The input data of the further processing model can nonetheless contain more information from the sensor data than when the input data is formed only by the points.

The surroundings sensor can be a radar sensor, a LiDAR sensor, a camera, in particular a stereo camera or a mono camera, a time-of-flight camera, a microphone or an ultrasonic sensor. The surroundings sensor can be disposed on a vehicle, in particular a motor vehicle, a two-wheeled vehicle, a bicycle, or on a mobile or stationary device, in particular a robot, a building, a traffic infrastructure or an industrial component.

The target object can be a living being, for example a person, an object, in particular a traffic sign, an installation, in particular a building and/or a plant, for example a tree, in the surroundings of the sensor.

The sensor data can be the result of processing sensor measurement data of the surroundings sensor. The sensor data can be in a form that allows certain attributes or characteristics of the sensor measurement data to be understood, quantified and/or interpreted. The sensor data can specify a frequency, an amplitude, a phase, a signal intensity, an object speed of the target object, an object distance of the target object, an angle of the target object, for example an azimuth angle or an elevation angle, a position of the target object, and/or an orientation of the target object. The sensor data can form the output data used to obtain the points of the point cloud.

In addition to the points and information sections, the input to the processing model can include other measurement parameters of the surroundings sensor, in particular modulation parameters, antenna parameters, calibration data, transmission parameters, reception parameters, filter parameters and/or processing parameters.

The points of the point cloud can be derived from the sensor data. A point of the point cloud represents at least one measured spatial coordinate of the reflection. A point can contain other parameters in addition to the spatial coordinate. The other parameters can be an angle, in particular an azimuth angle or an elevation angle, a radar cross-section (RCS), a speed and/or a reflection intensity. The point cloud provides a three-dimensional representation of the acquired target object and can be used to acquire the shape, size and orientation of the target object. The points can be assigned a respective Cartesian coordinate or polar coordinate, in particular a distance and an azimuth angle.

An information section can contain information from a subregion of the sensor data and/or a subregion of the sensor data.

According to an example embodiment of the present invention, the processing model can be a model learned from training data, in particular a deep learning model. The processing model can comprise a neural network.

According to an example embodiment of the present invention, the processing model can be a convolutional neural network (CNN). This uses convolutional layers, in particular two-dimensional convolutional layers, with convolutions for filtering and extracting features from the input data, in particular for the purpose of identifying spatial structures and patterns, for example textures or edges, in the input data. The convolutional layers can be sparse convolutions and execute the convolution only at the locations in the input data where information is actually present. For sparse input data, submanifold convolutions can be used, which limit the processing to the data that contains information and omit the informationless data while maintaining the original dimension of the input data.

According to an example embodiment of the present invention, the processing model can include at least one pooling layer. The pooling layer can form the last layer of the multilayered processing model, in particular for the purpose of obtaining a single feature vector for each point.

According to an example embodiment of the present invention, the processing model can be a recurrent neural network (RNN). This uses loops to store information over time and identify patterns across time sequences. The loops can transfer information from one time step to the next, in particular in order to model sequential and temporal dependencies.

The processing model can be a long short-term memory (LSTM). This uses gating mechanisms to address the issue of vanishing and exploding gradients in RNNs, in particular input, forget and output gates, in order to selectively add, store and retrieve information.

The processing model can be an autoencoder. This uses an encoder that converts the input data into a latent space and a decoder that converts the converted data back into the original space.

The processing model can be a support vector machine (SVM). This uses a separating line or hyperplane in multiple dimensions between classes of input data.

The processing model can be a transformer model. This uses the self-attention mechanism to take relationships between values of the input data into account, and in particular uses an encoder that converts the input data into a latent space.

The feature vector can be sensor-independent. Simultaneous and spatially matching acquisition of the target object with different surroundings sensors of a same or different sensor category can yield matching feature vectors after application of the individual processing models assigned to each surroundings sensor. Sensor-specific properties or measurement parameters can be included in the features of the feature vector. Further processing can thus be carried out independently of the surroundings sensor.

The output data of the processing model can be processed or they can form the input data of the further processing model directly. The data can be transferred via a data interface. The data interface can be a CAN bus.

According to an example embodiment of the present invention, the method for sensor data processing can be a computer-implemented method.

In a preferred embodiment of the present invention, the sensor data are divided into data bins as discretization elements and at least one data bin is assigned to each of the points as a point bin. The discretization element is a subregion of the sensor data. The data bins can be tiles of the sensor data subdivided into a lattice structure.

In a special configuration of the present invention, it is advantageous if the information sections assigned to the points comprise a plurality of data bins adjacent to the respective point bins. The information sections can be formed by the data bins. The information sections can include the point bin. The subregion of the sensor data covered by the respective information section is preferably larger than the subregion of the sensor data delimited by a data bin.

An advantageous preferred embodiment of the present invention is one in which the information sections assigned to the points comprise a plurality of data bins surrounding the respective point bins. The data bins can partly or completely surround the assigned point bin. An information section can include 7×7 data bins, for example. The point bin can be disposed in the center of the data bins. The information sections can be rectangular, square or any other shape.

In a preferred embodiment of the present invention, it is advantageous if the calculation of the feature vectors by the processing model and the further processing by the further processing model take place on calculation units which are different from one another. The calculation by the processing model can be carried out on the surroundings sensor itself, or on a calculation unit assigned individually, in particular exclusively, to the surroundings sensor. The calculation unit can process only the points and feature vectors of a single surroundings sensor.

According to an example embodiment of the present invention, the processing by the further processing model can be carried out on a central control unit. The processing can be carried out by a calculation unit that processes feature vectors and points of multiple surroundings sensors. For this purpose, the sensor data of the surroundings sensors can be processed by respective separate processing models in order to obtain the points and assigned feature vectors for each surroundings sensor. The data output by the processing models can be aggregated and passed on to a single further processing model or to multiple further processing models for further processing.

If one surroundings sensor of a plurality of surroundings sensors fails, is replaced or is modified, the processing model assigned to this sensor can likewise be modified or eliminated.

The other surroundings sensors and the processing models assigned to them can nonetheless continue to provide the outputs to the further processing model. It is thus possible to compensate the failure of a single surroundings sensor. There is no need to retrain the further processing model and the other processing models of the surroundings sensors.

If a surroundings sensor with the associated processing model is replaced, the new processing model can be trained again within the context of the existing further processing model and the existing other processing models of the other surroundings sensors. The parameters of the further processing model and/or the other processing models of the other surroundings sensors are preferably left unchanged when training the new processing model. The new processing model can thus be inserted without adjustments or without complex adjustments to the further processing model and the other processing models.

In a special configuration of the present invention, it is advantageous if the further processing model processes the points and feature vectors and from them calculate at least one object property of the target object. The further processing model can implement surroundings sensing, in particular object detection, object identification, object classification, semantic segmentation and/or localization. The further processing model can calculate a planning or function specification.

The further processing model can be a model learned from training data, in particular a deep learning model. The further processing model can comprise a neural network.

The further processing model can be a convolutional neural network (CNN). This uses convolutional layers with convolutions for filtering and extracting features from the input data, in particular for the purpose of identifying spatial structures and patterns, for example textures or edges, in the input data. The convolutional layers can be sparse convolutions and execute the convolution only at the locations in the input data where information is actually present. For sparse input data, submanifold convolutions can be used, which limit the processing to the data that contains information and omit the informationless data while maintaining the original dimension of the input data.

The further processing model can be a recurrent neural network (RNN). This uses loops to store information over time and identify patterns across time sequences. The loops can transfer information from one time step to the next, in particular in order to model sequential and temporal dependencies.

The further processing model can be a long short-term memory (LSTM). This uses gating mechanisms to address the issue of vanishing and exploding gradients in RNNs, in particular input, forget and output gates, in order to selectively add, store and retrieve information.

The further processing model can be an autoencoder. This uses an encoder that converts the input data into a latent space and a decoder that converts the converted data back into the original space.

The further processing model can be a support vector machine (SVM). This uses a separating line or hyperplane in multiple dimensions between classes of input data.

The further processing model can be a transformer model. This uses the self-attention mechanism to take relationships between values of the input data into account, and in particular uses an encoder that converts the input data into a latent space.

According to an example embodiment of the present invention, the further processing model can be trained by having other processing models of further surroundings sensors provide the input data for the processing model. The further processing model can be trained by hiding individual other processing models when the input data are compiled, in particular in order to be able to better head off a later failure of individual surroundings sensors and/or to better balance the weighting of the surroundings sensors, for example to mitigate against individual surroundings sensors having too much influence.

The processing model can be trained together with the further processing model. The training can use the gradient descent method. Backpropagation in the further processing model can calculate the gradient of the cost function for each weight and bias of the neural network of the further processing model. The calculated gradient at the input of the neural network can be used for backpropagation when training the processing model during joint training.

The processing model can be specifically trained for a task. An additional processing model for the same surroundings sensor can be trained to fulfill a different task. The processing model can be task-specifically trained. The processing model and the additional processing model can respectively output the points and feature vectors to the further processing model simultaneously or selectively, in particular depending on the desired task.

The object property of the target object can be an object distance, an angle, for example an azimuth angle or an elevation angle, a position, a pose and/or an orientation of the target object.

In a preferred example embodiment of the present invention, it is provided that the sensor data are available in the form of a spectrum. The spectrum can be a distances-speed spectrum, a frequency spectrum, a phase spectrum, a polarization spectrum, a power spectrum and/or a time spectrum.

The sensor data can alternatively be a time signal from a time-of-flight sensor, in particular a LiDAR sensor.

In a preferred example embodiment of the present invention, it is advantageous if the spectrum is at least two-dimensional. The spectrum can also be one-dimensional or higher-dimensional, in particular three-dimensional.

In a preferred example embodiment of the present invention, it is advantageous if, as a result of the processing in the processing model, the feature vectors respectively contain information derived from the associated information sections. The features contained in the dimensions of the feature vector can be compressed and/or aggregated information of the associated information sections. The features contained in the feature vector can be encoded information of the information sections. The feature vector can contain, in particular encoded, information about a variance, a signal strength and/or a peak extension of the sensor data.

The feature vector can contain a plurality of features, for example 32 features. Each feature can have a predefined bit size, for example 16 bit. The feature vector can be one-dimensional.

According to an example embodiment of the present invention, a processing device is also provided, which is configured with at least one of the previously described features to carry out the method for sensor data processing and comprises a surroundings sensor for acquiring at least one target object in the surroundings of the sensor, a calculation unit for executing the processing model and a calculation unit for executing the further processing model. The calculation unit for executing the processing model can be formed by the surroundings sensor itself, or by a calculation unit assigned individually, in particular exclusively, to the surroundings sensor. The calculation unit can process only the points and feature vectors of a single surroundings sensor.

The calculation unit for executing the further processing model can be formed by a central control unit. This calculation unit can process the feature vectors and points of multiple surroundings sensors.

Further advantages and advantageous embodiments of the present invention will emerge from the description of the figure.

### BRIEF DESCRIPTION OF THE DRAWING

FIG. 1 shows a method for sensor data processor according to an example embodiment of the present invention.

### DETAILED DESCRIPTION OF EXAMPLE EMBODIMENTS

Example embodiments of the present invention are described in detail in the following with reference to the figure.

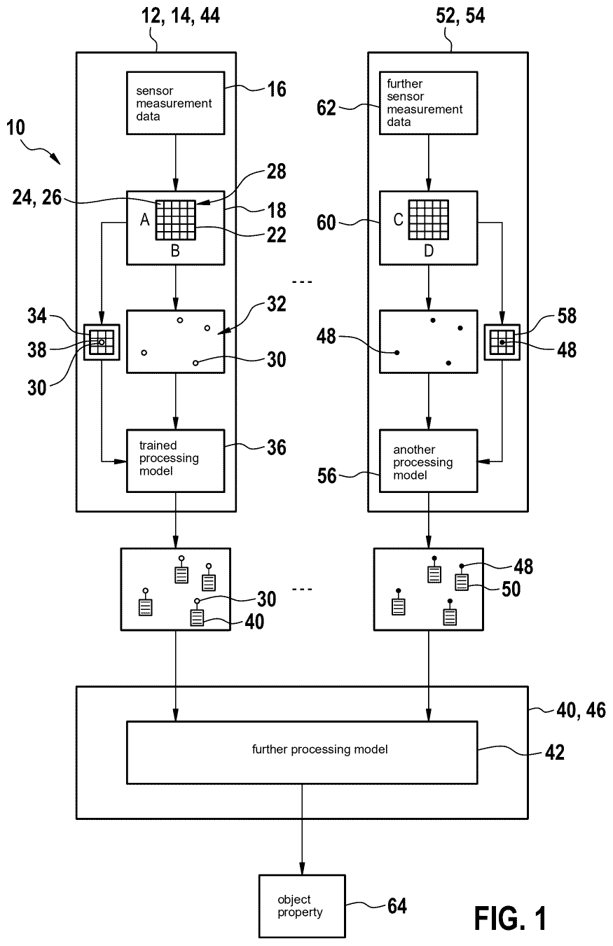

FIG. 1 shows a method for sensor data processing in a specific embodiment of the present invention. The method for sensor data processing 10 processes the information coming from at least one surroundings sensor 12, for example a radar sensor 14. The surroundings sensor 12 acquires at least one target object in the surroundings of the sensor and thus provides sensor measurement data 16. Raw signal processing is used to calculate sensor data 18 available as a two-dimensional spectrum 22 having two dimensions A, B from the sensor measurement data 16. The spectrum 22 can be a distance-speed spectrum. The sensor data 18 are preferably divided into data bins 24 as discretization elements 26. The data bins 24 can be tiles of the spectrum 22 subdivided into a lattice structure 28.

Points 30 assigned to reflections of the target object are derived from the sensor data 18 and form a point cloud 32 in a spatial distribution corresponding to the reflections. The points 30 are input into a trained processing model 36 together with these assigned information sections 34 of the sensor data 18. Each information section 34 is a region of data bins 24 comprising a plurality of tiles of the two-dimensional spectrum 22, for example. The information section 34 assigned to a respective point 30 is a subregion of the spectrum 22 comprising 3×3 data bins 24, for instance, in the center of which lies the point bin 38 respectively assigned to the point 30.

The processing model 36 can be a model learned from training data, in particular a deep learning model, and preferably comprises a neural network. The processing model 36 calculates feature vectors 40 respectively assigned to the points 30 for further processing by a further processing model 42. As a result of the processing in the processing model 36, the feature vectors 40 respectively contain information derived from the associated information sections 34. This information can be compressed and aggregated information from the associated information sections 34, in particular encoded information.

The calculation of the feature vectors 40 by the processing model 36 and the further processing by the further processing model 42 take place on calculation units 44 which are different from one another. The calculation by the processing model 36 is in particular carried out on the surroundings sensor 12 itself as the calculation unit 44. The processing by the further processing model 42 is preferably carried out on a central control unit 46 as the calculation unit, which receives and processes the data output by the processing model 36.

The further processing model 42 in particular comprises further input data in the form of further points 48 and associated further feature vectors 50 of a further surroundings sensor 52, for example a LiDAR sensor 54. The further feature vectors 50 assigned to the further points 48 are in particular calculated by another processing model 56 assigned to the further surroundings sensor 52 depending on the further points 48 and associated further information sections 58 of further sensor data 60 of the further surroundings sensor 52. The further sensor data 60 are calculated from further sensor measurement data 62 of the further surroundings sensor 52 and are provided as a further spectrum with the dimensions C, D.

The points 30 and assigned feature vectors 40 and the further points 48 and further feature vectors 50 can be a form of data representation that is independent of the specific form of the sensor data 18 and further sensor data 60, as a result of which the specific measurements of respective surroundings sensors 12, 52 are encoded in a standardized format. The further processing model 42 processes the points 30 and feature vectors 40 of the surroundings sensor 12, the further points 48 and further feature vectors 50 of the further surroundings sensor 52 and further outputs of possible other surroundings sensors and from them calculates at least one object property 64 of the target object. The further processing model 42 can implement surroundings sensing, in particular object detection. The further processing model 42 in particular comprises an object detection network and is preferably trained, in particular by deep learning. The object property 64 of the target object can be an object distance, an angle, for example an azimuth angle or an elevation angle, a position, a pose and/or an orientation of the acquired target object.

What is claimed is:

1. A method for sensor data processing of sensor data of a surroundings sensor, the method comprising the following steps:
providing the sensor data of the surroundings sensor acquiring at least one target object in surroundings of the sensor;
calculating a point cloud including a spatial distribution of a plurality of points assigned to respective reflections of the target object from the sensor data;
inputting the points and information sections of the sensor data respectively assigned to the points to a trained processing model;
calculating feature vectors assigned to the points by the processing model depending on the input; and
outputting the points and the assigned feature vectors for further processing by a further processing model.

2. The method for sensor data processing according to claim 1, wherein the sensor data are divided into data bins as discretization elements and at least one of the data bins is assigned to each of the points as a respective point bin.

3. The method for sensor data processing according to claim 2, wherein the information sections assigned to the points include a plurality of data bins adjacent to the respective point bins.

4. The method for sensor data processing according to claim 2, wherein the information sections assigned to the points include a plurality of data bins surrounding the respective point bins.

5. The method for sensor data processing according to claim 1, wherein the calculation of the feature vectors by the processing model and the further processing by the further processing model take place on calculation units which are different from one another.

6. The method for sensor data processing according to claim 1, wherein the further processing model processes the points and the feature vectors and from the points and the feature vectors calculates at least one object property of the target object.

7. The method for sensor data processing according to claim 1, wherein the sensor data are in the form of a spectrum.

8. The method for sensor data processing according to claim 7, wherein the spectrum is at least two-dimensional.

9. The method for sensor data processing according to claim 1, wherein, as a result of processing in the processing model, the feature vectors respectively contain information derived from the information sections.

10. A processing device configured to process sensor data, the processing device comprising:
a surroundings sensor configured to acquire at least one target object in the surroundings of the sensor;
a first calculation unit configured to execute a trained processing model; and
a second calculation unit configured to execute a further processing model;
wherein the processing device is configured to:
provide sensor data of the surroundings sensor acquiring the at least one target object in the surroundings of the sensor,
calculate a point cloud including a spatial distribution of a plurality of points assigned to respective reflections of the target object from the sensor data,
input the points and information sections of the sensor data respectively assigned to the points to a trained processing model,
calculate feature vectors assigned to the points by the processing model depending on the input, and
output the points and the assigned feature vectors for further processing by the further processing model.
